(19) United States
(12) Patent Application Publication
(10) Pub. No.: US 2006/0017742 A1
(43) Pub. Date: Jan. 26, 2006

(54) Method of one point color tracking

(75) Inventor: Ching-Hsiang Hsu, Taipei (TW)

Correspondence Address: DENNISON, SCHULTZ, DOUGHERTY;& MACDONALD, SUITE 105, 1727 KING STREET, ALEXANDRIA, VA, 22314-2700, US

(73) Assignee: VASTVIEW TECHNOLOGY INC.

(21) Appl. No.: 10/896,974

(22) Filed: Jul. 23, 2004

(51) Int. Cl. G09G 5/02

(52) U.S. Cl. 345/589

(57) ABSTRACT

A method of one point color tracking is for the color tracking of the screen panel that executes the tracking operation of the chromatic coordinates for the measured values of screen color parameter by using of the specific parameter values of the chromatic coordinates to get the screen color parameter tracking value and the lookup table of the color parameter tracking value, and to compare the color of the screen color parameter tracking value with the color of the measured values of screen color parameter so as to decide whether the steps of the color tracking stated above are repeated or not. Thereby, a method of one point color tracking can be provided for color display with high preciseness and steadiness. The method can suit for the color display devices such as liquid crystal display panels, plasma display panels, thin film transistor displays or organic light-emitting displays etc.

### BACKGROUND OF THE INVENTION

1. Field of the Invention

The present invention relates to a method of one point color tracking, especially to a method in which the tracking operation of chromatic coordinate is executed for the measured value of the screen color parameter by using of the specific chromatic coordinate parameter value to get the screen color parameter tracking value and the lookup table (LUT) of the color parameter tracking value, and the colors of the screen color parameter tracking value and the measured value of the screen color parameter are compared to decide whether the steps of the color tracking are repeated or not. Thereby a method of one point color tracking can be provided for the color display with high preciseness and steadiness. The method of one point color tracking according to the present invention can suit for the color display devices such as liquid crystal display panels (LCD panel), plasma display panels (PDP), thin film transistor (TFT) displays or organic light-emitting displays (OLED, PLED) etc.

2. Description of the Prior Art

Since the liquid crystal display was discovered, it has been a very important subject for the liquid crystal display industry how to process display and change the color for the different brightness. The reason caused this subject comes chiefly from the material the liquid crystal display—the liquid crystal molecular. The factors, which make the effect of the color on the liquid crystal display panel be not so good as on the traditional image tube (CRT) screen, are the physical property of the gamma dispersion of the liquid crystal molecular, the limit of the real object, and the structure design of liquid crystal display.

There are two modes for the liquid crystal display panel applied no voltage: the normally white (NW) mode and the normally black (NB) mode, wherein the normally white mode is that the display panel is transparent, i.e. bright, when it is applied no voltage, the normally black mode is that the display panel is opaque, i.e. black, when it is applied no voltage. The various voltages can be applied to make the liquid crystal molecular turn some angle and refract the light in such a manner that the expected color can be displayed.

Generally, the color temperature of the light source is defined as the temperature of the black body, when the light color of the light source is the same as the color of the black body at a given temperature, and it is expressed with the absolute temperature scale K (Kelvin). When the color of the light emitted from the light source approaches the color of the block body at a given temperature, the temperature of the black body is then called the correlated color temperature of the light source and its unit is K. The light source with color temperature (or the correlated color temperature) below 3300 k is reddish, it gives people warm feeling, and the light source with color temperature above 5300 k is bluish, it gives people cool feeling.

In the prior art, to promote and enhance the color display ability of the existing liquid crystal display, many persons in this field develop various methods for color tracking on the base of the color temperature, such as the color tracking of the liquid crystal display developed by Hitachi Company of Japan and the method of normally white mode in hologram back light improved by Samsung Company of Korea. However, according to the results of experiment and study, it is not easy to accomplish precise and steady color display by the method in which the correlated color temperature is kept at a given dispersed region in the change process between the normally white mode and the normally black mode of the liquid crystal display.

Besides color temperature, there is chromatic coordinate among the color parameters for the color display of the liquid crystal display. The chromatic coordinate is a standard system for brightness and color made by an international organization, Commission Internationale de I'clairage (C.I.E.). In 1960 C.I.E. brought forth an equal ratio chromatic coordinate system of UVW uniform color mode, of which characteristic is that the color variation ratio is nearly equal in the chromatic coordinate. In 1960 C.I.E. also brought forth the U*V*W* chromatic coordinate system, which is an improvement of the equal ratio chromatic coordinate of the UVW uniform color mode.

The L*a*b* chromatic coordinate system is made by taking cubic root of the three colored coordinates, and the L*u*v* color system came from L*a*b* chromatic coordinate system in 1976. The YUV chromatic coordinate system of separate color mode is used for the signal communication of color wired television in PAL system (used in Germany, China, Greece, and England) or SELAM system (used in Russia).

There is a correlation between the color temperature and the chromatic coordinate: The color temperature of a given color can correspond to a relatively wide region of chromatic coordinates, but the chromatic coordinate of the same color can much precisely correspond to the color temperatures (correlated color temperature) with nearly same region. Referring to FIG. 6, for the original curve of the screen panel, when the gray level value decreases from 250 to 50, the corresponding correlated color temperature varies from 10000 to 35000 k, i.e. the difference of the correlated color temperatures between gray level value 250 and 50 is 25000 k. However, it can be nearly kept at 10000 k in the same variation of the gray level value for the color tracking on the base of the chromatic coordinate, the preciseness and steadiness of the color display can be largely promoted as shown in FIGS. 7 and 8.

Therefore, the present invention wants to provide a method of one point color tracking on the base of the chromatic coordinate, which can respond the color precisely and steadily and has better effect of color display for the screen panel.

### SUMMARY OF THE INVENTION

The primary object of the present invention is to provide a method of one point color tracking for the color display with high preciseness and steadiness. In this method, the tracking operation of chromatic coordinate is executed for the measured value of the screen color parameter by using of the specific chromatic coordinate parameter value to get the screen color parameter tracking value and the lookup table (LUT) of the color parameter tracking value, and the color; of the screen color parameter tracking value and the measured value of the screen color parameter are compared to decide whether the steps of the color tracking are repeated or not, thereby a color display with high preciseness and steadiness can be provided.

To achieve the above object, a method of one point color tracking according the present invention, which is used for the color tracking of the screen panel, includes a measured value receiving unit of screen color parameter, a color parameter setting unit, a chromatic coordinate calculation unit, a simulated display unit and a writing and recording unit. The method includes of the following steps:
(1) Measured values of the screen color parameter are received by the measured value receiving unit of screen color parameter;
(2) Specific parameter values are input in the color parameter setting unit;
(3) The chromatic coordinate calculation unit executes a tracking operation of the chromatic coordinate for the measured value of the color parameter by using of the specific color parameter value to obtain a screen color parameter tracking value and a lookup table (LUT) of the color parameter tracking value;
(4) The screen color parameter tracking value and the measured value of the color parameter are simultaneously displayed in the simulated display unit;
(5) The simulated display unit displays the colors of the screen color parameter tracking value and the measured value of the color parameter at the same time;
(6) The screen color parameter tracking value is written and recorded in the writing and recording unit; and
(7) If the screen color parameter tracking value does not satisfy the user, the step (1) to (6) are then operated again;

By using of the steps stated above, the fine color tracking can be executed for the screen panel.

To let the present invention be able to be clearly understood, there are some preferred embodiments stated in detail as the following.

### BRIEF DESCRIPTION OF THE DRAWINGS

FIG. 1 is a flow chart of a first embodiment of the present invention;

FIG. 2 is the step chart of the first embodiment of the present invention;

FIG. 3 is a flow chart of a second embodiment of the present invention;

FIG. 4 is the step chart of the second embodiment of the present invention;

FIG. 5 is a flow chart of a third embodiment of the present invention;

FIG. 6 is the step chart of the third embodiment of the present invention;

FIG. 7 is a flow chart of a fourth embodiment of the present invention;

FIG. 8 is the step chart of the fourth embodiment of the present invention;

FIG. 9 is a view showing an embodiment of the human-machine interface of the present invention;

FIG. 10 is a view showing the color temperature curves of the original and the after-tracking of the screen panel;

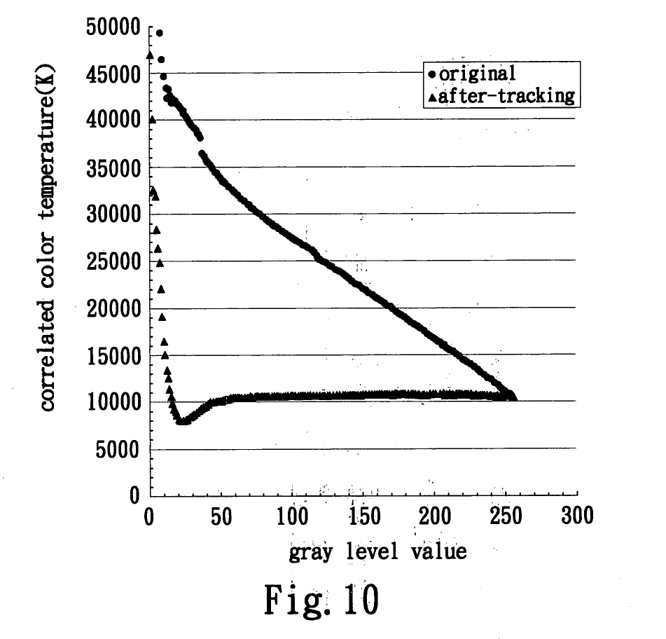

FIG. 11 is a view showing the original chromatic coordinates diagram of the screen panel; and

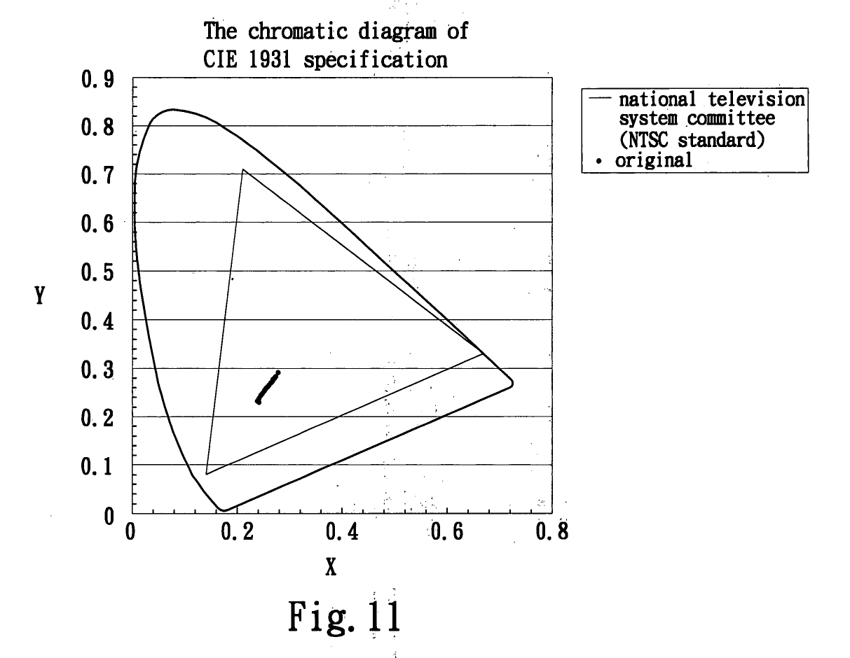

FIG. 12 is a view showing the chromatic coordinates diagram after color tracking of the screen panel.

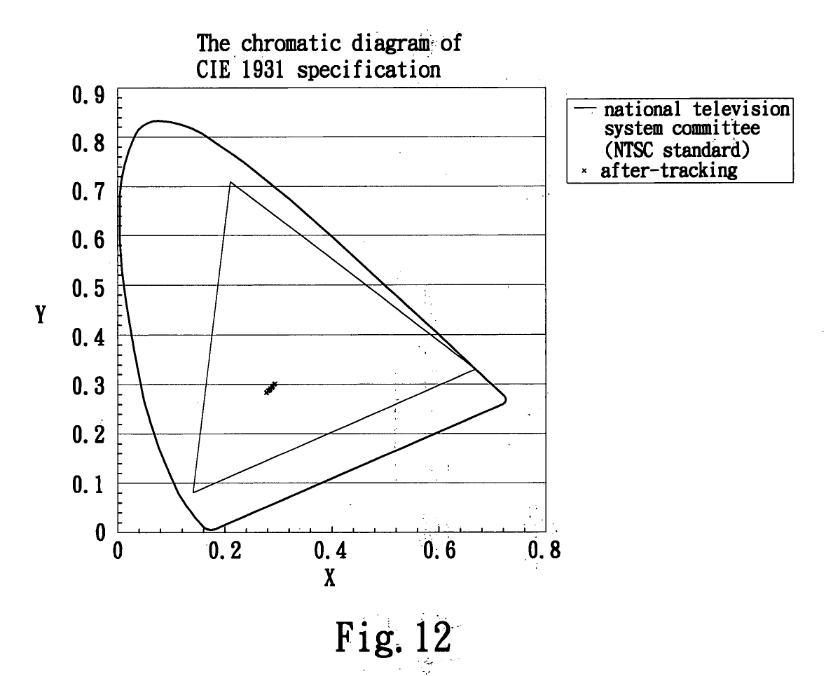

### DETAILED DESCRIPTION OF THE PREFERRED EMBODIMENT

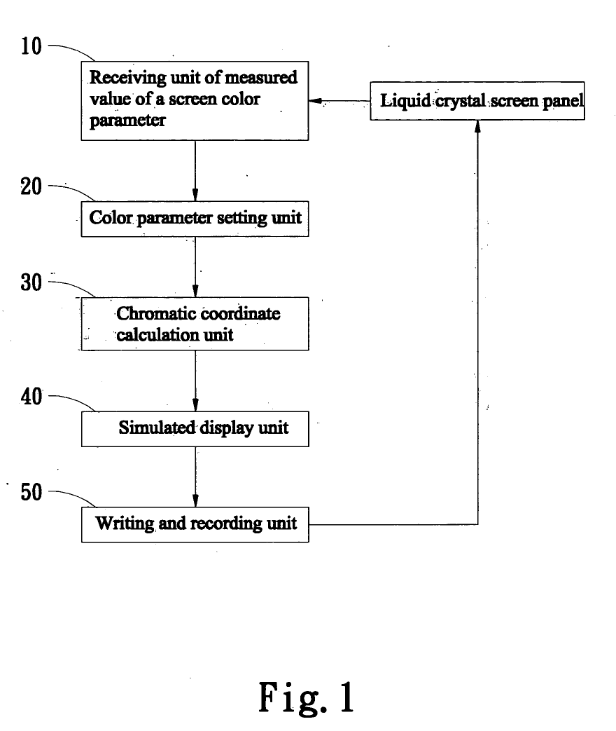

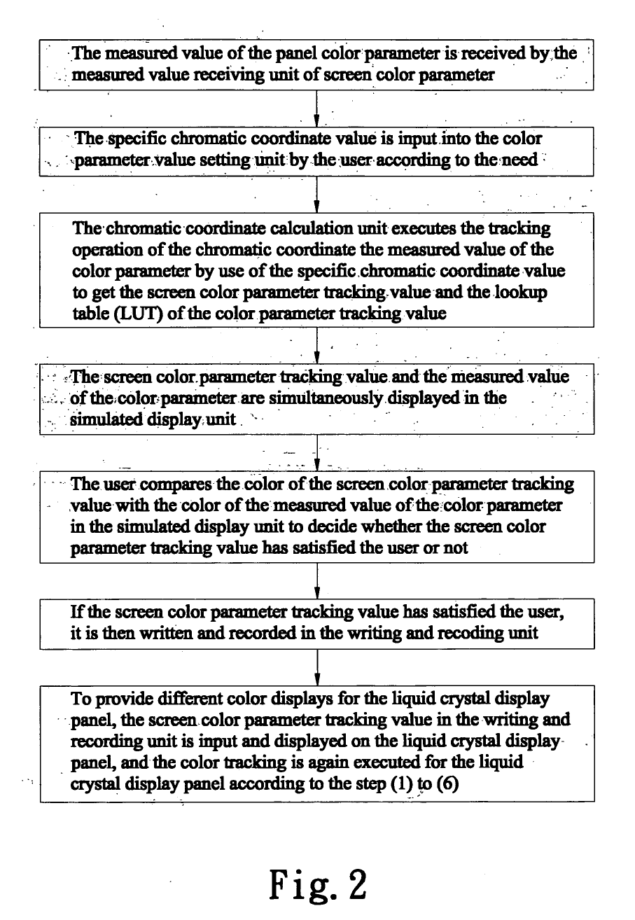

Referring to FIGS. 1 and 2, a first embodiment of the present invention relates to the color tracking of the liquid crystal display panel. It includes a measured value receiving unit of screen color parameter 10, a color parameter value setting unit 20, a chromatic coordinate calculation unit 30, a simulated display unit 40 and a writing and recording unit 50. It includes the following steps:
(1) The measured value of the color parameter of the liquid crystal display panel is received by the measured value receiving unit of screen color parameter 10;
(2) The specific chromatic coordinate value is input into the color parameter value setting unit 20 by the user according to the need;
(3) The chromatic coordinate calculation unit 30 executes the tracking operation of the chromatic coordinate for the measured value of the color parameter by using of the specific chromatic coordinate value to get the screen color parameter tracking value and the lookup table (LUT) of the color parameter tracking value;
(4) The screen color parameter tracking value and the measured value of the color parameter are simultaneously displayed in the simulated display unit 40;
(5) The user compares the color of the screen color parameter tracking value with the color of the measured value of the color parameter in the simulated display unit 40 to decide whether the screen color parameter tracking value has satisfied the user or not;
(6) If the screen color parameter tracking value has satisfied the user, it is then written and recorded in the writing and recoding unit 50;
(7) To provide different color displays for the liquid crystal display panel, the screen color parameter tracking value in the writing and recording unit 50 is input and displayed on the liquid crystal display panel, and the color tracking is again executed for the liquid crystal display panel according to the step (1) to (6);

By the steps stated above, the precise color tracking of the liquid crystal display panel can be repeatedly executed and there are eight groups of different tracking values of the screen color parameter can be written and recorded in the writing and recording unit 50.

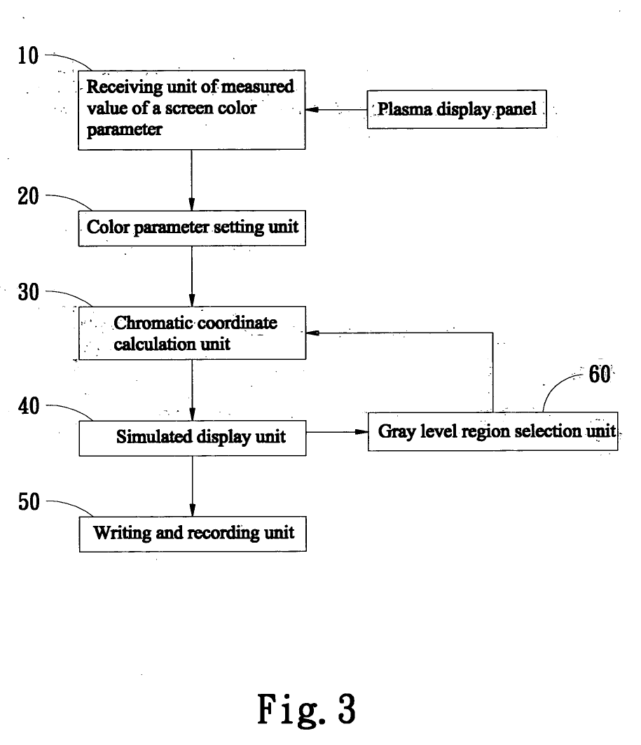

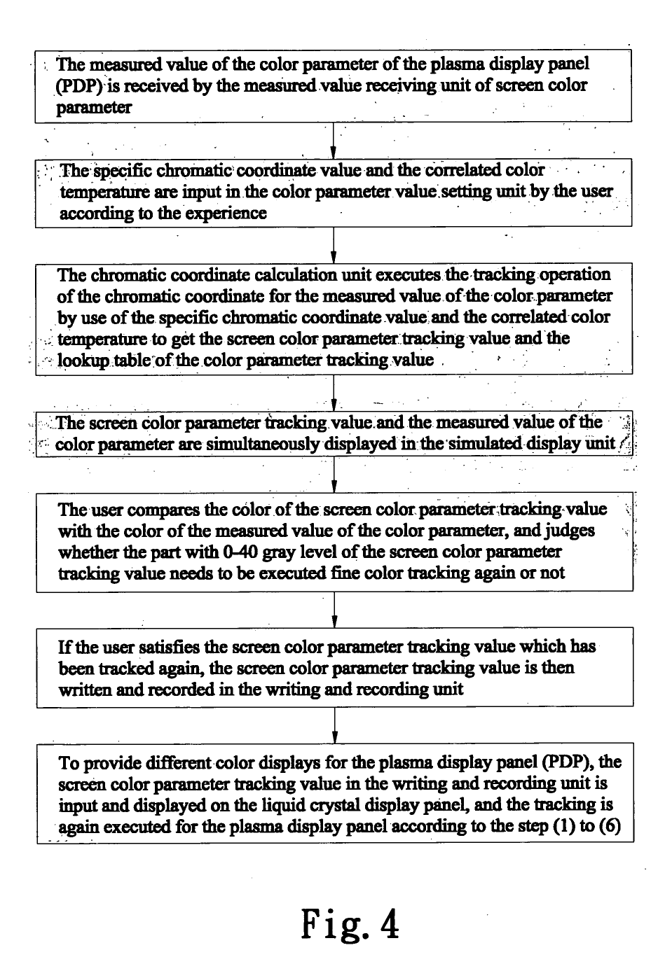

The second embodiment of the present invention is shown in FIGS. 3 and 4, which includes a measured value receiving unit of screen color parameter 10, a color parameter value setting unit 20, a chromatic coordinate calculation unit 30, a simulated display unit 40, a writing and recording unit 50 and a gray level region selection unit 60. It includes the following steps:
(1) The measured value of the color parameter of the plasma display panel (PDP) is received by the measured value receiving unit of screen color parameter 10;
(2) The specific chromatic coordinate value and the correlated color temperature are input in the color parameter value setting unit 20 by the user according to the experience;
(3) The chromatic coordinate calculation unit 30 executes the tracking operation of the chromatic coordinate for the measured value of the color parameter by using of the specific chromatic coordinate value and the correlated color temperature to get the screen color parameter tracking value and the lookup table of the color parameter tracking value;
(4) The screen color parameter tracking value and the measured value of the color parameter are simultaneously displayed in the simulated display unit 40;
(5) The user compares the color of the screen color parameter tracking value with the color of the measured value of the color parameter, and judges whether the part with 0-40 gray level of the screen color parameter tracking value needs to be executed fine color tracking again or not;
(6) The user selects the part with 0-40 gray level of the screen color parameter tracking value by the gray level region selection unit 60 to be again operated for tracking in the chromatic coordinate calculation unit 30, and the screen color parameter tracking value and the screen color parameter tracking value which has been tracked again are expressed in the simulated display unit 40;
(7) If the user satisfies the screen color parameter tracking value which has been tracked again, the screen color parameter tracking value is then written and recorded in the writing and recording unit 50; and
(8) To provide different color displays for the plasma display panel (PDP), the screen color parameter tracking value in the writing and recording unit 50 is input and displayed on the liquid crystal display panel, and the tracking is again executed for the plasma display panel according to the step (1) to (6);

By the steps stated above, the precise color tracking of the plasma display panel can be repeatedly operated, and there are eight groups of different tracking values of the screen color parameter can be written and recorded in the writing and recording unit 50.

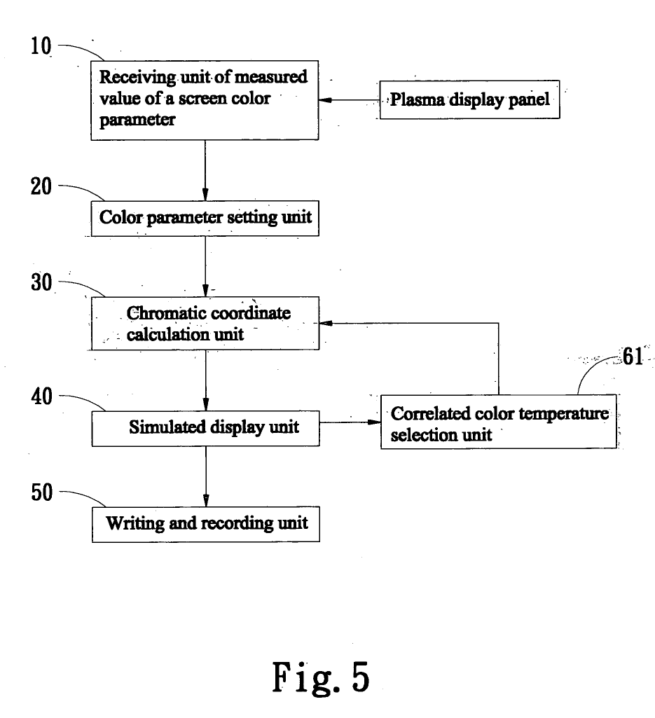

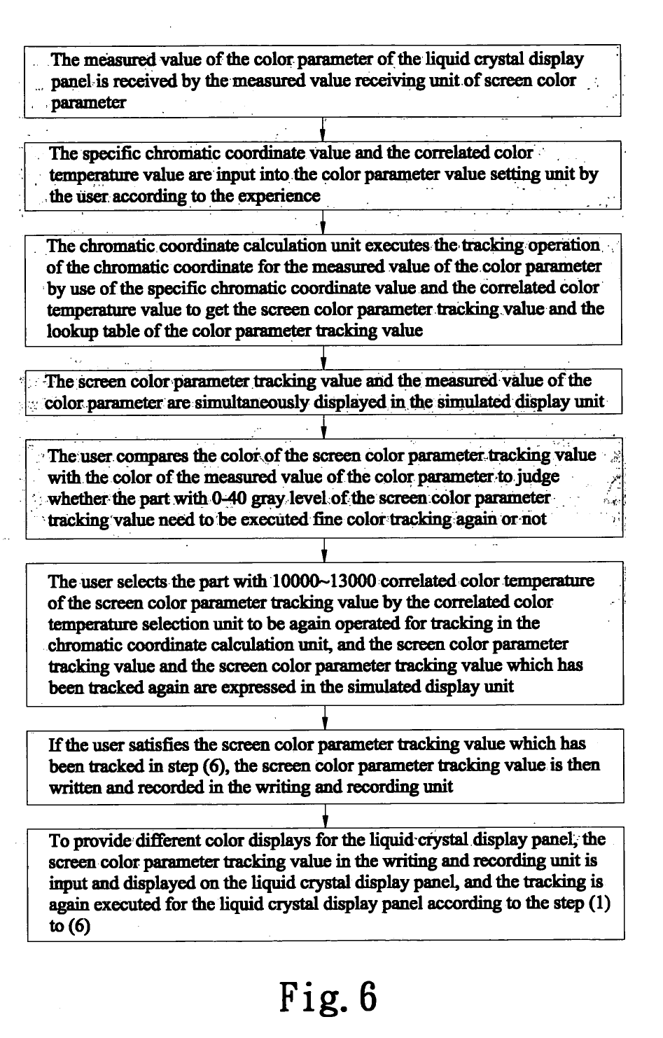

The third embodiment of the present invention is shown in FIGS. 5 and 6, which includes a measured value receiving unit of screen color parameter 10, a color parameter value setting unit 20, a chromatic coordinate calculation unit 30, a simulated display unit 40, a writing and recording unit 50 and a correlated color temperature selection unit 61. The method includes the following steps:
(1) The measured value of the color parameter of the liquid crystal display panel is received by the measured value receiving unit of screen color parameter 10;
(2) The specific chromatic coordinate value and the correlated color temperature value are input into the color parameter value setting unit 20 by the user according to the experience;
(3) The chromatic coordinate calculation unit 30 executes the tracking operation of the chromatic coordinate for the measured value of the color parameter by using of the specific chromatic coordinate value and the correlated color temperature value to get the screen color parameter tracking value and the lookup table of the color parameter tracking value;
(4) The screen color parameter tracking value and the measured value of the color parameter are simultaneously displayed in the simulated display unit 40;
(5) The user compares the color of the screen color parameter tracking value with the color of the measured value of the color parameter to judge whether the part with 0-40 gray level of the screen color parameter tracking value need to be executed fine color tracking again or not;
(6) The user selects the part with 10000-13000 correlated color temperature of the screen color parameter tracking value by the correlated color temperature selection unit 61 to be again operated for tracking in the chromatic coordinate calculation unit 30, and the screen color parameter tracking value and the screen color parameter tracking value which has been tracked again are expressed in the simulated display unit 40;
(7) If the user satisfies the screen color parameter tracking value which has been tracked in step (6), the screen color parameter tracking value is then written and recorded in the writing and recording unit 50; and
(8) To provide different color displays for the liquid crystal display panel, the screen color parameter tracking value in the writing and recording unit 50 is input and displayed on the liquid crystal display panel, and the tracking is again executed for the liquid crystal display panel according to the step (1) to (6);

By the steps stated above, the precise color tracing of the liquid crystal display panel can be repeatedly executed and there are eight groups of different tracking values of the screen color parameter can be written and recorded in the writing and recording unit 50.

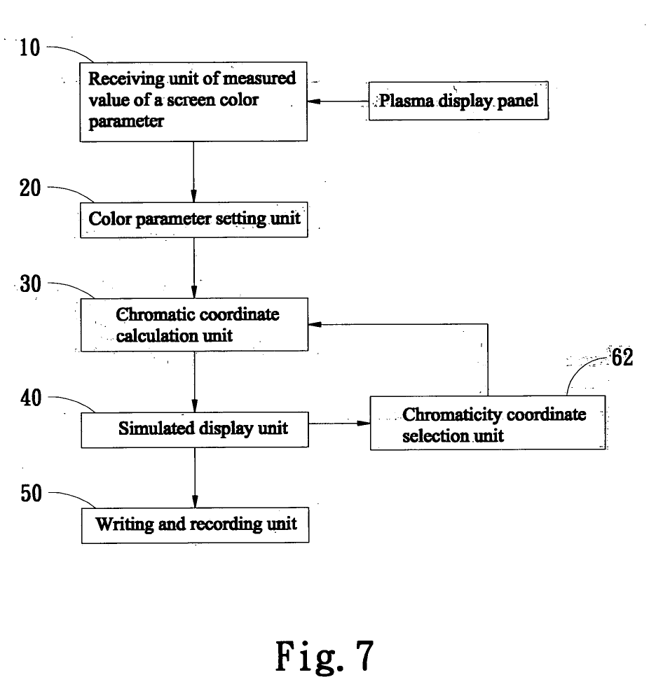

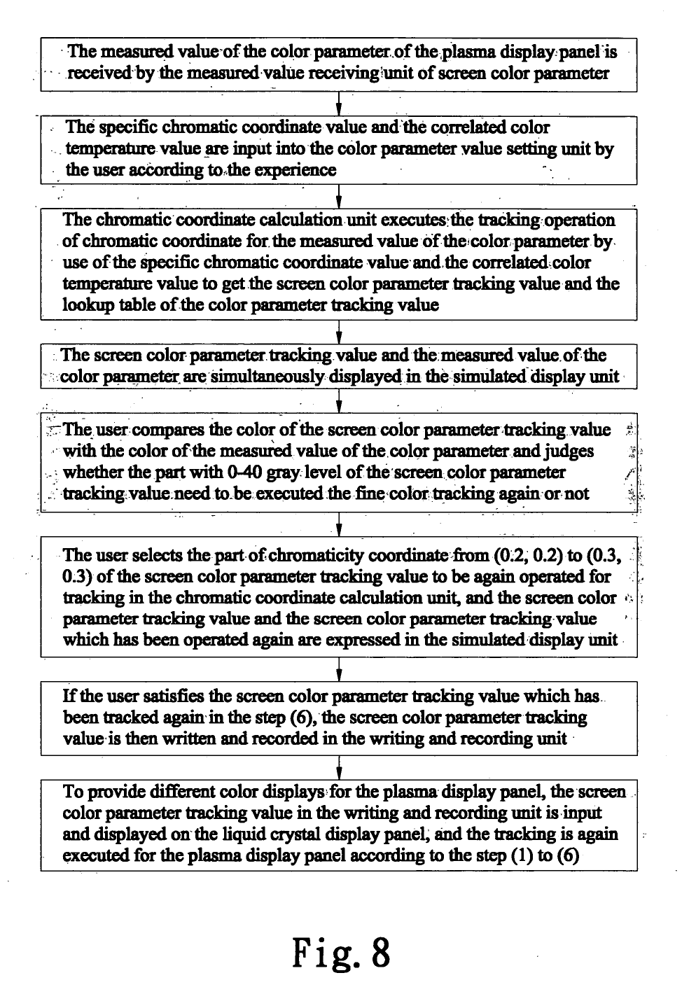

The fourth embodiment of the present invention is shown in FIGS. 7 and 8, which includes a measured value receiving unit of screen color parameter 10, a color parameter value setting unit 20, a chromatic coordinate calculation unit 30, a simulated display unit 40, a writing and recording unit 50 and a chromatic coordinate selection unit 62. The method consists of the following steps:
(1) The measured value of the color parameter of the plasma display panel is received by the measured value receiving unit of screen color parameter 10;
(2) The specific chromatic coordinate value and the correlated color temperature value are input into the color parameter value setting unit 20 by the user according to the experience;
(3) The chromatic coordinate calculation unit 30 executes the tracking operation of chromatic coordinate for the measured value of the color parameter by using of the specific chromatic coordinate value and the correlated color temperature value to get the screen color parameter tracking value and the lookup table of the color parameter tracking value;
(4) The screen color parameter tracking value and the measured value of the color parameter are simultaneously displayed in the simulated display unit 40;
(5) The user compares the color of the screen color parameter tracking value with the color of the measured value of the color parameter and judges whether the part with 0-40 gray level of the screen color parameter tracking value need to be executed the fine color tracking again or not;
(6) The user selects the part of chromatic coordinate from (0.2, 0.2) to (0.3, 0.3) of the screen color parameter tracking value to be again operated for tracking in the chromatic coordinate calculation unit 30, and the screen color parameter tracking value and the screen color parameter tracking value which has been operated again are expressed in the simulated display unit 40;
(7) If the user satisfies the screen color parameter tracking value which has been tracked again in the step (6), the screen color parameter tracking value is then written and recorded in the writing and recording unit 50;
(8) To provide different color displays for the plasma display panel, the screen color parameter tracking value in the writing and recording unit 50 is input and displayed on the liquid crystal display panel, and the tracking is again executed for the plasma display panel according to the step (1) to (6);

By the step stated above, the precise color tracking of the plasma display panel can be repeatedly executed and there are eight groups of different tracking values of the screen color parameter can be written and recorded in the writing and recording unit 50.

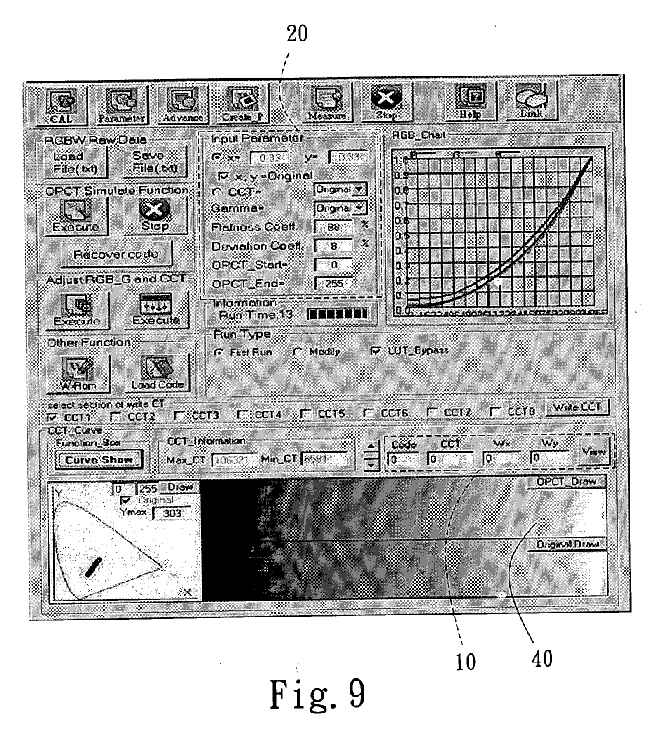

An embodiment of the human-machine interface of the present invention is shown in FIG. 9. At the lower portion of the human-machine interface is the simulated display unit 40, which can display the colors of the screen color parameter tracking value and the measured value of the color parameter at the same time to provide the base of the judgment for the user. At the right-upper portion of the simulated display unit 40 is the measured value receiving unit of screen color parameter 10. At the middle-upper portion of the human-machine interface is the color parameter value setting unit 20, which provides color parameter value such as chromatic coordinate and correlated color temperature for the user to track.

The above statements are only the some embodiments for disclosing the present invention. They cannot be used to limit the scope of the present invention. All the apparent variations and applications made by the persons who are skilled at the field related to the present invention ought to be regarded as the contents of the present invention.

Therefore, the present invention has the following advantages:
1. The present invention executes the operation of the color tracking on the base of the chromatic coordinate. When the brightness gray level changes, the dispersed region of the corresponding color temperature can be effectively reduced. Therefore, the present invention can display the color on the screen panel more precisely than the traditional method, which executes the operation of the color tracking on the base of the color temperature.
2. The present invention can precisely display the color on the screen panel, so the brightness and the clearness of the panel color can be effectively promoted.
3. The present invention can precisely display the color on the screen panel, so the color variation corresponding to the specific brightness gray level can be reduced and the steadiness of the display can be enhanced.

To sum up, according to the contents disclosed above, the present invention indeed can achieve its expected objects. In the present invention, the tracking operation of the chromatic coordinate is executed for the measured value of the screen color parameter by using of the specific chromatic coordinate parameter value to get the screen color parameter tracking value and the lookup table of the color parameter tracking value, and the colors of the measured value of the screen color parameter and the screen color parameter tracking value are compared to decide whether the steps for color tracking are repeated or not, thereby a method of one point color tracking can be provided for the color display of the screen panel with high preciseness and steadiness. The present invention can suit for various color display devices and has very high industrial value, so it is brought forward for claiming patent right.

What is claimed is:

1. A method of one point color tracking for color tracking of a screen panel, comprising a measured value receiving unit of screen color parameter, a color parameter setting unit, a chromatic coordinate calculation unit, a simulated display unit and a writing and recording unit, including the following steps:
(1) measured values of screen color parameter being received by said measured value receiving unit of screen color parameter;
(2) specific color parameter values being input in said color parameter setting unit;
(3) said chromatic coordinate calculation unit executing a tracking operation of said chromatic coordinate to said measured value of the color parameter by using of said specific color parameter value to get a screen color parameter tracking value and a lookup table (LUT) of the color parameter tracking value;
(4) said screen color parameter tracking value and said measured value of the color parameter being simultaneously displayed in said simulated display unit;
(5) said simulated display unit displaying colors of said screen color parameter tracking value and said measured value of the color parameter at the same time;
(6) said screen color parameter tracking value being written and recorded in said writing and recording unit; and
(7) if said screen color parameter tracking value does not satisfy a user, said screen color parameter tracking value in said writing and recording unit being then input and displayed on said screen panel and tracked again according to the steps (1) to (6);
by using of said steps stated above, said color tracking of said screen panel can be exactly executed.

2. The method of one point color tracking as claimed in claim 1, wherein said color parameter value setting unit includes a chromatic coordinate and a correlated color temperature.

3. The method of one point color tracking as claimed in claim 1, wherein said measured value of said screen color parameter is said color parameter value for displaying on said screen panel.

4. The method of one point color tracking as claimed in claim 1, further including a gray level region selection unit in which said user can select a specific gray level region of said screen color parameter tracking value in said simulated display unit to execute the fine color tracking for said specific gray level region.

5. The method of one point color tracking as claimed in claim 1, further including a correlated color temperature selection unit in which said user can select a specific correlated color temperature region of said screen color parameter tracking value in said simulated display unit to execute the fine color tracking for said specific correlated color temperature region.

6. The method of one point color tracking as claimed in claim 1, further including a chromatic coordinate calculation unit in which said user can select a specific chromatic coordinate region of said screen color parameter tracking value in said simulated display unit to execute the fine color tracking for said specific chromatic coordinate region.

7. The method of one point color tracking as claimed in claim 6, wherein said chromatic coordinate calculation unit is on the base of the CIE 1931 xy chromatic coordinate standard.

8. The method of one point color tracking as claimed in claim 1, wherein said screen panel is liquid crystal display panel (LCD panel), plasma display panel (PDP), thin film transistor (TFT) display or organic light-excited display (OLED, PLED).
